(19) United States
(12) Patent Application Publication
(10) Pub. No.: US 2024/0000011 A1
(43) Pub. Date: Jan. 4, 2024

(54) COMBINE UNLOADING ON-THE-GO WITH BIN LEVEL SHARING AND ASSOCIATED DEVICES, SYSTEMS, AND METHODS

(71) Applicant: Ag Leader Technology, Ames, IA (US)

(72) Inventors: Roger Zielke, Huxley, IA (US); Tony Woodcock, Ames, IA (US)

(21) Appl. No.: 18/217,216

(22) Filed: Jun. 30, 2023

Related U.S. Application Data
(60) Provisional application No. 63/357,284, filed on Jun. 30, 2022.

(51) Int. Cl. A01D 41/127; A01D 90/10; G08B 21/18

(52) U.S. Cl. CPC A01D 41/1275; A01D 41/1272; A01D 90/10; G08B 21/18

(57) ABSTRACT

A combine unloading management system comprising one or more processors and one or more computer-readable storage media comprising instructions that configure the one or more processors to: determine a grain flow rate of grain flowing into a combine tank of a combine harvesting along a current pass of a grain field; determine a combine tank level corresponding to a current amount of grain in the combine tank; and determine a starting point for unloading the combine tank on-the-go into a grain cart, the starting point based on the grain flow rate and the combine tank level.

### CROSS-REFERENCE TO RELATED APPLICATION(S)

This application claims the benefit under 35 U.S.C. § 119(e) to U.S. Provisional Application No. 63/357,284 filed Jun. 30, 2022, and entitled “Grain Cart Bin Level Sharing,” which is hereby incorporated herein by reference in its entirety.

### TECHNICAL FIELD

The disclosed technology generally relates to agricultural harvesting and crop/grain unloading, and more particularly relates to unloading on-the-go.

### BACKGROUND

As would be understood farmers often utilize combines and grain carts to harvest large amount of crop efficiently. Known combines typically have a built-in grain tank, which is also called a bin or hopper. The combine bin fills with grain as the field is harvested and must be periodically unloaded into another container to avoid overflowing.

It would be understood by those of skill in the art that unloading a full combine bin can sometimes take two to three minutes. “Unloading on-the-go” refers to unloading while the combine continues to harvest. While combines can unload when stationary, many farmers prefer “unloading on-the-go” in order to minimize combine downtime and maximize the amount of time for harvesting. That is, rather than stopping the combine to unload the crop into a grain cart for two to three minutes, the grain cart drives alongside the combine for a period of time for the combine to unload the harvested crop into the grain cart while continuing to harvest additional crop.

It is further understood that a grain cart is a mobile grain storage container commonly used to unload a combine, optionally on-the-go or while stationary but while remaining in a field. Grain carts are typically pulled by an agricultural tractor in order to shuttle grain unloaded from the combine to another hauling vehicle, usually parked at the field edge. The hauling vehicle is typically a truck or wagon suited for hauling grain on roadways to a semi-permanent storage location.

In many cases, the grain cart bin size is about twice the size of the combine bin. This means about two full combine unloads will fill an empty grain bin. As would be understood, when harvesting corn, the combine is often stopped at the onset of the first unload because the combine bin fills before the grain cart can return to the combine from offloading to a transport vehicle or storage/transportation solution, typically at the edge of a field or harvesting area. After the first unload, the grain cart typically waits in the field for the combine to harvest enough corn to completely fill the grain cart in a second unload event.

There is a need in the art for improvements to unloading combines into grain carts during harvest operations.

### BRIEF SUMMARY

In Example 1, a combine unloading management system comprising one or more processors and one or more computer-readable storage media comprising instructions that configure the one or more processors to: determine a grain flow rate of grain flowing into a combine tank of a combine harvesting along a current pass of a grain field; determine a combine tank level corresponding to a current amount of grain in the combine tank; and determine a starting point for unloading the combine tank on-the-go into a grain cart, the starting point based on the grain flow rate and the combine tank level.

Example 2 relates to the combine unloading management system of Example 1, wherein the one or more processors are configured to wirelessly transmit the starting point to a display for viewing by an operator of the grain cart.

Example 3 relates to the combine unloading management system of any of Examples 1-2, wherein the starting point comprises a position in the current pass or a subsequent pass at which the combine will start unloading on-the-go into the grain cart.

Example 4 relates to the combine unloading management system of any of Examples 1-3, wherein the starting point comprises a time at which the combine will start unloading on-the-go into the grain cart.

Example 5 relates to the combine unloading management system of any of Examples 1-4, wherein the one or more processors are configured to determine a plurality of starting points for unloading the combine tank on-the-go into the grain cart and select one of the plurality of starting points that is closest to a current position of the combine.

Example 6 relates to the combine unloading management system of any of Examples 1-5, wherein the plurality of starting points comprises at least two of: a first starting point so that the combine tank is about full at the first starting point before unloading; a second starting point so that the grain cart is about full and the combine tank is about empty after unloading on-the-go into the grain cart; and a third starting point so that the combine tank is about empty at an end of the current pass after unloading on-the-go into the grain cart.

Example 7 relates to the combine unloading management system of any of Examples 1-6, further comprising a grain mass flow sensor and an empty tank level sensor, and wherein the one or more processors are configured to determine the grain flow rate based on an average of a grain mass value received from the grain mass flow sensor since last receiving an empty tank signal from the empty tank level sensor.

Example 8 relates to the combine unloading management system of any of Examples 1-7, wherein the one or more processors are configured to determine the grain flow rate of the current pass based on a grain flow rate of a previously harvested pass.

In Example 9, a combine unloading management system comprising: a first controller disposed on a combine, the first controller comprising a housing, a first radio, and a first processor mounted within the housing in operative communication with the first radio and configured to: determine a grain flow rate of grain flowing into a combine tank of the combine as the combine harvests along a current pass of a grain field; determine a combine tank level corresponding to a current amount of grain in the combine tank; determine a starting point for unloading the combine tank on-the-go into a grain cart, the starting point based on the grain flow rate and the combine tank level; and transmit the starting point to the grain cart with the first radio.

Example 10 relates to the combine unloading management system of Example 9, further comprising a grain mass flow sensor and an empty tank level sensor, wherein the first processor is further configured to: receive a grain mass value from the grain mass flow sensor; receive an empty tank signal from the empty tank level sensor; and determine the grain flow rate based on an average of the grain mass value since last receiving the empty tank signal.

Example 11 relates to the combine unloading management system of any of Examples 9-10, wherein the first processor is further configured to determine the grain flow rate of the current pass based on a grain flow rate of a previously harvested pass.

Example 12 relates to the combine unloading management system of any of Examples 9-11, wherein the first processor is further configured to determine the starting point additionally based on a combine tank capacity of the combine tank so that the combine tank is about full at the starting point before unloading on-the-go into the grain cart.

Example 13 relates to the combine unloading management system of any of Examples 9-12, further comprising a second controller disposed on the grain cart, the second controller comprising a housing, a second radio, and a second processor mounted in operative communication with the second radio and configured to receive the starting point with the second radio and display the starting point for viewing by an operator of the grain cart.

Example 14 relates to the combine unloading management system of any of Examples 9-13, wherein the second processor is further configured to transmit a grain cart level and a grain cart capacity of the grain cart to the first controller with the second radio, and wherein the first processor is further configured to: determine the starting point additionally based on the grain cart level, the grain cart capacity, and an unload auger rate of the combine; and determine the starting point so that the grain cart is about full and the combine tank is about empty after unloading the combine tank on-the-go into the grain cart.

Example 15 relates to the combine unloading management system of any of Examples 9-14, wherein the first processor is further configured to: determine the starting point additionally based on an unload auger rate of the combine, a speed of the combine, and a remaining distance of the current pass to be harvested; and determine the starting point so that the combine tank is about empty at an end of the current pass after unloading the combine tank on-the-go into the grain cart.

Example 16 relates to the combine unloading management system of any of Examples 9-15, wherein the first processor is further configured to determine a plurality of starting points and select one of the plurality of starting points corresponding to a shortest distance from a current position of the combine and/or corresponding to a shortest time period before unloading the combine tank on-the-go into the grain cart.

In Example 17, a method for managing unloading on-the-go of a combine, comprising: determining, with one or more processors, a grain flow rate of grain flowing into a combine tank of a combine harvesting along a current pass of a grain field; determining, with the one or more processors, a combine tank level corresponding to a current amount of grain in the combine tank; determining, with the one or more processors, a starting point for unloading the combine tank on-the-go into a grain cart, the starting point based on the grain flow rate and the combine tank level; and wirelessly transmitting the starting point to a display for viewing by an operator of the grain cart.

Example 18 relates to the method of Example 17, further comprising determining, with the one or more processors, a plurality of starting points for unloading the combine tank on-the-go into the grain cart and selecting one of the plurality of starting points corresponding to a shortest distance from a current position of the combine and/or corresponding to a shortest time period before unloading the combine tank on-the-go into the grain cart.

Example 19 relates to the method of any of Examples 17-18, wherein the plurality of starting points comprises at least two of: a first starting point so that the combine tank is about full at the first starting point before unloading; a second starting point so that the grain cart is about full and the combine tank is about empty after unloading the go into the grain cart; and a third starting point so that the combine tank is about empty at an end of the current pass after unloading on-the-go into the grain cart.

Example 20 relates to the method of any of Examples 17-19, further comprising determining, with the one or more processors, the grain flow rate based on an average of the output of a grain mass flow sensor since last receiving, with the one or more processors, an empty tank signal corresponding to the combine tank being empty.

In Example 21, a method for alerting a grain cart operator when a combine auger is on and off, comprising: detecting the on/off status of the combine auger; transmitting the on/off status of the combine auger to a grain cart; and issuing an audible and/or visual alarm to alert a grain cart operator of the on/off status of the combine auger.

Example 22 relates to the system of Example 21, wherein the alarm is an audible alarm with a first distinct sound to indicate auger on and a second distinct sound to indicate auger off.

Example 23 relates to the system of any of Examples 21-22, wherein the on/off status of the combine auger is detected via electronic messages from a combine electronic system or motion sensor on the combine auger.

Example 24 relates to the system of any of Examples 21-23, wherein the on/off status of the combine auger is detected via a grain cart scale system, wherein when the grain cart scale system detects the combine auger is on when the grain cart scale system detects a continuous weight increase for a threshold period of time.

While multiple implementations and aspects are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an illustration of a combine unloading on-the-go into a grain cart, according to one implementation.

FIG. 2 is a schematic diagram of a combine unloading management system, according to one implementation.

FIG. 3 is a diagram of a user interface for a combine unloading management system, according to one implementation.

FIG. 4 is a diagram of a combine unloading algorithm, according to one implementation.

FIG. 5A is a diagram illustrating a starting point for unloading a combine on-the-go, according to one implementation.

FIG. 5B is a diagram illustrating a next pass starting point for unloading a combine on-the-go, according to one implementation.

FIG. 6 is a diagram illustrating a starting point for unloading a combine on-the-go where the combine grain tank will get full, according to one implementation.

FIG. 7 is a diagram illustrating a starting point for unloading a combine on-the-go that will fill the grain cart the quickest, according to one implementation.

FIG. 8 is a diagram illustrating a starting point for unloading a combine on-the-go that will empty the combine tank by the end of the pass, according to one implementation.

FIG. 9 is a diagram illustrating a measurement of a previous pass, according to one implementation.

FIG. 10 is a diagram illustrating the change in combine unload auger flow rate by corn moisture.

### DETAILED DESCRIPTION

Disclosed herein are various devices systems and methods for unloading crops on-the-go, that is transferring harvested crop from a harvester into a transportation vehicle, such as from a combine to a grain cart. The various systems, methods, and devices described herein include a monitoring and control system for sharing information between vehicles regarding crop levels within the various vehicles, such that transfer of crops between vehicles can be done efficiently and effectively, optionally on-the-go. In various implementations the systems, methods, and devices are configured for automatically or semi-automatically commanding vehicles for unloading, optionally on-the-go.

The various implementations disclosed herein will be discussed in reference to a combine and grain cart style operation, but this is not intended to be limiting as the system can be modified to operate with many alternative known harvest and transport vehicles.

As noted above, in corn harvesting operations the grain cart is typically waiting on the combine at a second unload, while the combine is typically waiting on the grain cart for the first unload. In order to maximize efficiency in harvest operations it is advantageous to determine when and where to start unloading for both the first and second unloads, where a grain cart requires two unloads to become full. But it is particularly useful for the second unload because it is at that point that the grain cart is waiting on the combine to complete enough harvesting to fill the grain cart bin.

In crops other than corn, it is useful to determine when and where to start unloading into the cart at all times because for many alternative crops the cart is always waiting on the harvest to harvest enough crops that unloading is necessary and/or advantageous. Various additional factors such as grain cart size, field shapes, use of multiple harvesters and/or grain carts in the same field/harvest area, different crops can influence the time and/or place at which unloading is desired. The described systems, methods, and devices dynamically determine when to start unloading on-the-go based on current feedback from the harvest operation, and optionally prior data. This determination may always be useful but may particularly be useful at time where the grain cart is waiting of the harvester.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. Patent Application 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/215,721, filed Jun. 28, 2023, entitled “Seed Tube Guard and Associated Systems, Devices, and Methods of Use,” U.S. Patent Application 63/394,843, filed Aug. 3, 2022, entitled “Hydraulic Cylinder Position Control for Lifting and Lowering Towed Implements,” U.S. Patent Application 63/395,061, filed Aug. 4, 2022, entitled “Seed Placement in Furrow,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” and U.S. Patent Application 63/466,560, filed May 15, 2023, entitled “Devices, Systems, and Methods for Agricultural Guidance and Navigation,” each of which is incorporated herein by reference.

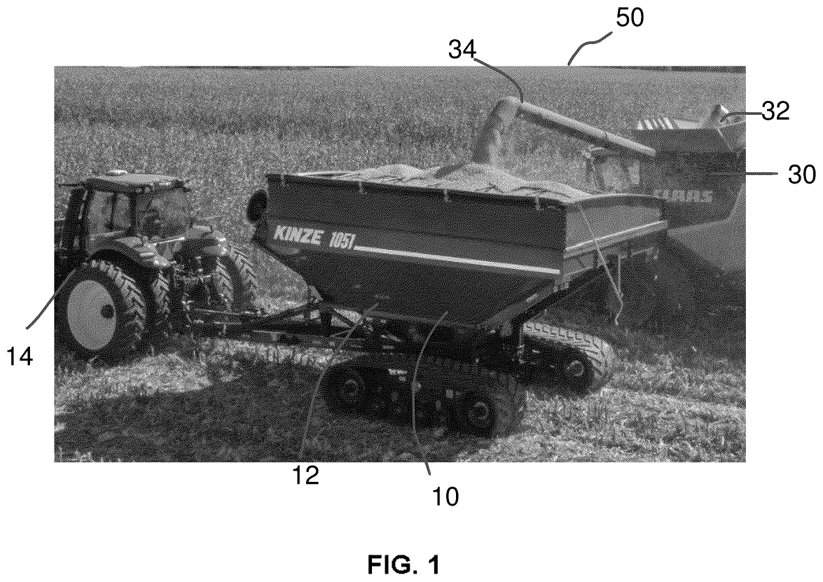

Turning now to the figures in more detail, FIG. 1 is a depiction of a combine unloading management system 50 in action according to various implementations. In this example, the system 50 includes various components (e.g., control systems and sensors) that are mounted, disposed, or otherwise associated with a combine 30 unloading on-the-go into a grain cart 10. Among other things, the combine 20 includes a combine tank 32 that feeds a combine unload auger 34, which is unloading grain into the grain cart 10 while continuing to harvest. The combine 30 may also stop harvesting to unload crops, as would be understood.

The combine tank 32 has a maximum capacity and current or live bin level, which are sometimes referred to herein as a combine tank capacity and a combine tank level, respectively. The grain cart 10 includes a tank 12 that receives the grain unloaded from the combine 30. The cart tank 12 has a maximum capacity and a live bin level, referred to herein respectively as a grain cart capacity and a grain cart level. The grain cart 10 is being pulled by an agricultural vehicle 14, which in this case is a tractor 14. Grain carts 10 may be pulled by any other appropriate vehicle, may be self-propelled, and/or autonomously driven, as would be understood.

As would be appreciated, grain carts 10 are commonly equipped with a scale system that measures the grain weight in the grain cart 10 tank 12. In various of the implementations disclosed herein the weight of the grain in the grain cart 10 tank 12 is the grain cart level. In various cases the scale system is referred to as a bin level system or grain cart level system.

It would also be understood that combines 30 typically do not have bin scales, but instead include a grain mass flow sensor(s) that measure the grain flow rate into the combine bin 32. A detailed explanation of a combine bin level system is provided in U.S. Pat. No. 9,043,096 which is hereby incorporated by reference in its entirety. As used herein a bin level or tank level is the amount of crop in the combine 30 or grain cart 10 tank at any given time. The bin level may also be referred to as a live bin level or live tank level.

As would be appreciated, the grain cart 10 and combine 30 bin are volumetric containers, yet the levels of grain within the containers are typically measured by weight. The weight-to-volume ratio of the harvested grain affects the maximum capacity of the container (grain cart 10 and/or combine 30 bin). Therefore, the capacity of the containers is adjusted for each harvested crop type and may have to be adjusted within each crop type depending on the actual/expected weight-to-volume ratio of the harvested crop. As would be understood, moisture content of the harvested crop can influence the maximum capacity of the containers. In various implementations, the system 50 may use the crop moisture reported by the yield monitor, or other appropriate sensor, to automatically adjust the maximum capacity of the containers.

In various implementations, the monitor and control system 50 wirelessly shares data about combine 30 and grain cart 10 bin levels. For example, the system 50 may be operationally integrated into a farm management system, such as InCommand® from Ag Leader®, whereby data can be shared between the various vehicle—combines 30 and grain carts 10—during harvest operations. Various alternative methods and devices are possible for sharing data between and about the vehicles and would be understood. The system 50 may optionally be implemented to automatically or semi-automatically determine when and where to begin and end unloading of a crop from the harvest vehicle 30 to the transport vehicle 10, as will be described further herein. The system 50 may also optionally be implemented to automatically control the unloading of crop, optionally on-the-go. Still further, the system 50 may be implemented to issue audio and/or visual alerts to operators regarding the on/off status of the combine unload auger.

As would be understood by those of skill in the art, operators must determine when and where to begin and end crop unloading/transfer during harvest. That is, the harvest vehicle 30 (such as a combine 30) has a limited capacity to hold harvested crops and as such must be periodically unloaded or crop transferred to a transport vehicle 10 (such as a grain cart 10) in order to continue harvest operations. The determine of when and where to begin unloading/transfer is influenced by a number of factors including, but not limited to, crop yield, harvester throughput, and combine/grain cart bin size.

With many prior known systems and methods for unloading/transferring crop, particularly corn, the unloading/transfer of crop from the combine to grain cart is a bottleneck in the harvesting process. That is the combine and/or grain cart are often waiting on one another to be in appropriate place and fill state to begin unloading. For example, when the combine bin 32 becomes full it must stop harvesting and be emptied into a grain cart 10. If the grain cart 10 is not nearby when the combine bin 32 becomes full harvest operations must stop for an extended period to allow the grain cart 10 to catch up and collect the grain to be unloaded. The disclosed system 50 can determine when and where to begin and end unloading of a combine on-the-go, such that harvesting by the combine 30 does not need to stop due to tank 32 being full.

In various implementations, the system 50 can be configured to prioritize keeping the combine 30 unloaded, such that the combine 30 will, rarely if ever, need to stop harvesting due to a full tank 32. In further implementations, the system 50 may alternatively or additionally prioritize filling a grain cart 10 quickly such that it can fill a further hauling vehicle or storage container and return to the combine 30 for further unloading of crops. In a still further implementation, the system 50 may additionally or alternatively prioritize ending a harvesting pass with the combine bin 32 empty or near empty. Various additional or alternative priorities may be implemented by the system 50 such as minimizing travel distance for a grain cart, minimizing soil compaction, and the others, as would be appreciated.

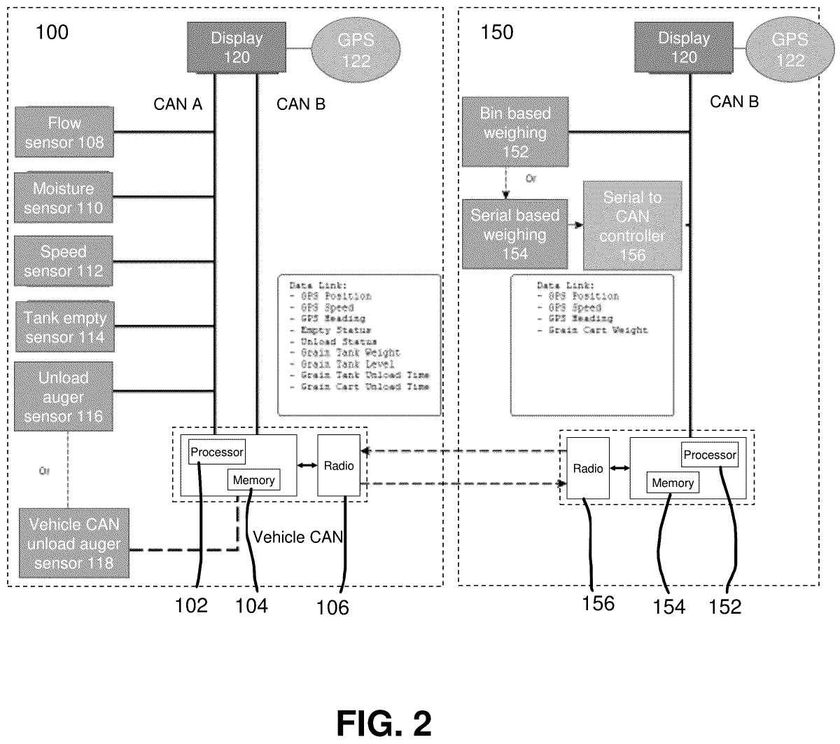

FIG. 2 is a schematic diagram of a monitoring and control system 50, according to certain implementations. In the depicted example, the system 50 (also referred to herein as an unloading management system 50) includes a combine subsystem 100 in wireless (e.g., radio) communication with a grain cart subsystem 150. The combine subsystem 100 includes a computer processor 102 in communication a computer-readable storage medium 104, such as computer memory. The storage medium 104 includes instructions that, when executed by the processor 102, configure the processor 102 to carry out various actions and steps according to the disclosed technology. The processor 102 is operatively connected with a radio 106, which enables the combine subsystem 100 to wirelessly communicate with the grain cart subsystem 150.

As shown in FIG. 2, in various implementations the grain cart subsystem 150 also includes a computer processor 152 in communication a computer-readable storage medium 154. The storage medium 154 includes instructions that, when executed by the processor 152, configure the processor 152 to carry out various actions and steps according to the disclosed technology. The processor 152 is operatively connected with a radio 156, which enables the grain cart subsystem 150 to wirelessly communicate with the combine subsystem 100.

In various implementations, the data link between the combine subsystem 100 and grain cart subsystem 150 (a combine radio 106 to a grain cart radio 156) can transfer various data including, but not limited to GPS position of either vehicle, speed (as determined by GPS or other sensor), heading (optionally determined by GPS), combine fill/empty status, combine unload auger on/off status, combine tank weight, combine tank level, combine tank unload time, grain cart weight, grain cart unload time, and other data as would be understood and as will be discussed further herein.

According to various implementations, the processors 102, 152 are microcontrollers, although other devices such as, but not limited to, Central Processing Units (CPUs), microprocessors, Field Programmable Gate Arrays (FPGAs), and Application Specific Integrated Circuits (ASICs) are possible. As shown, in various cases the processors 102, 152 include or are coupled with one or more physical, non-transitory computer accessible or readable storage devices 104, 154, which are also referred to herein as “memory” and “memory devices.” The memory 104, 154 may be implemented using any suitable memory technology, which may include, e.g., temporary and more long-term configurations, volatile and non-volatile configurations, and solid state and/or other physical formats. Examples of possible memory 104, 154 include random access memory (RAM), dynamic random-access memory (DRAM), static random-access memory (SRAM), magnetic hard discs, optical discs, floppy discs, flash memory, forms of electrically programmable memory (EPROM) and electrically erasable and programmable (EEPROM) memory, and other forms known in the art.

According to various implementations, the memory devices 104, 154 contain instructions for configuring the processors 102, 152 to perform particular operations or actions by virtue of loading and executing the instructions. The processors 102, 152 carrying out the instructions cause the combine unloading management system 50 to carry out the desired actions. References herein to the processors 102, 152, subsystems, and/or management system 50 carrying out various activities imply that the one or more of the processors 102, 152 are configured with corresponding instructions for execution.

Continuing with reference to FIG. 2, in various implementations the combine subsystem 100 includes one or more additional components in operative communication with the processor 102. For example, in some cases the processor 102 is operatively connected (e.g., through a CAN) with a grain mass flow sensor or yield monitor 108, a moisture sensor 110, a speed sensor 112, an empty tank level sensor 114, and one or more unload auger sensors 116, 118. In various implementations the processor 102 is operatively connected to a display 120. One example of a display 120 is the display unit sold under the name InCommand® by Ag Leader®. Various alternative displays are also possible including agriculture specific display products, tablets such as Apple iPad®, and the like, as would be appreciated. As would be appreciated the display 120 may be a component of or embodiment of a farm management system.

In certain implementations, one or more algorithms or instructions may be executed by the display 120 thereby reducing or eliminating the need for additional processors and/or control units, as would be understood.

It would be appreciated that functions of various sensors 108, 110, 112, 114, 116, 118 may be omitted, substituted, or combined in various implementations of the system 50. The system 50 may also include additional sensors, not depicted, including for example a three-quarters full sensor, a full bin level sensor, and others as would be appreciated.

In various implementations, the system 50 further includes or is operatively connected by a GPS or GNSS unit 122. The GPS 122 receiver may locate and transmit a location, speed, and/or heading of the vehicle during operation.

FIG. 2 further depicts a grain cart subsystem 150. The grain cart subsystem 150 may optionally include a display 120 and GPS 122 receiver similar to those discussed above with reference to the combine subsystem. The grain cart subsystem 150 may also include one or more additional components including a scale system 152 or bin based weighing system 152 with an optional serial. In implementations with a serial based weighing system 154, the system 154 may be connected to the processor 152 via a controller 156.

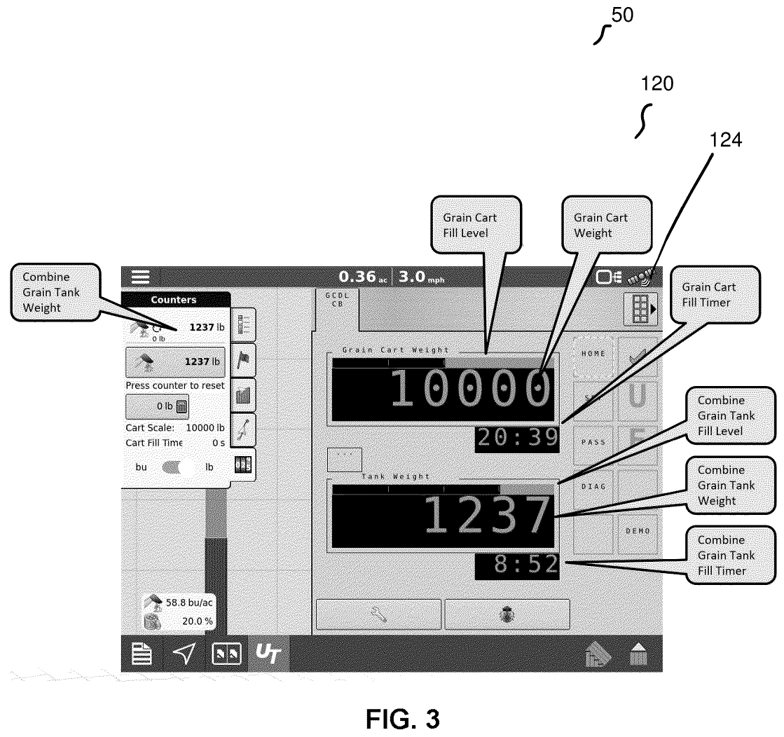

An exemplary display 120 dashboard 124 is shown in FIG. 3. The dashboard 124 may display to an operator various data including but not limited to the combine grain tank weight, the grain cart fill level, the grain cart weight, a grain cart fill timer, the combine grain tank fill level, the combine grain tank weight, a combine grain tank fill timer, and the like. The display 120 and dashboard, may be further configured to display an unload start time/location to the operators. In various implementations, the dashboard 124 may be customizable to display only that information desired or needed by a particular operator. In certain implementations, the dashboard 124 may display the same information to both a grain cart operator and a combine operator.

In various implementations, as will be discussed in further detail herein, the system 50 is configured to determine unloading/transfer start/stop locations based on various data which may include tank/bin level, crop flow rate, crop yield, crop moisture, vehicle position, vehicle speed, vehicle heading, pass length, and/or other data as would be appreciated. In various implementations, the system 50 may make assumptions based for various data such as from past harvest years, adjacent rows, recent passes, and the like. That is, in certain implementations, the system 50 may make assumptions about an upcoming pass based on data from a previous or reference pass, as will be discussed further herein.

### Unloading Start Schemes

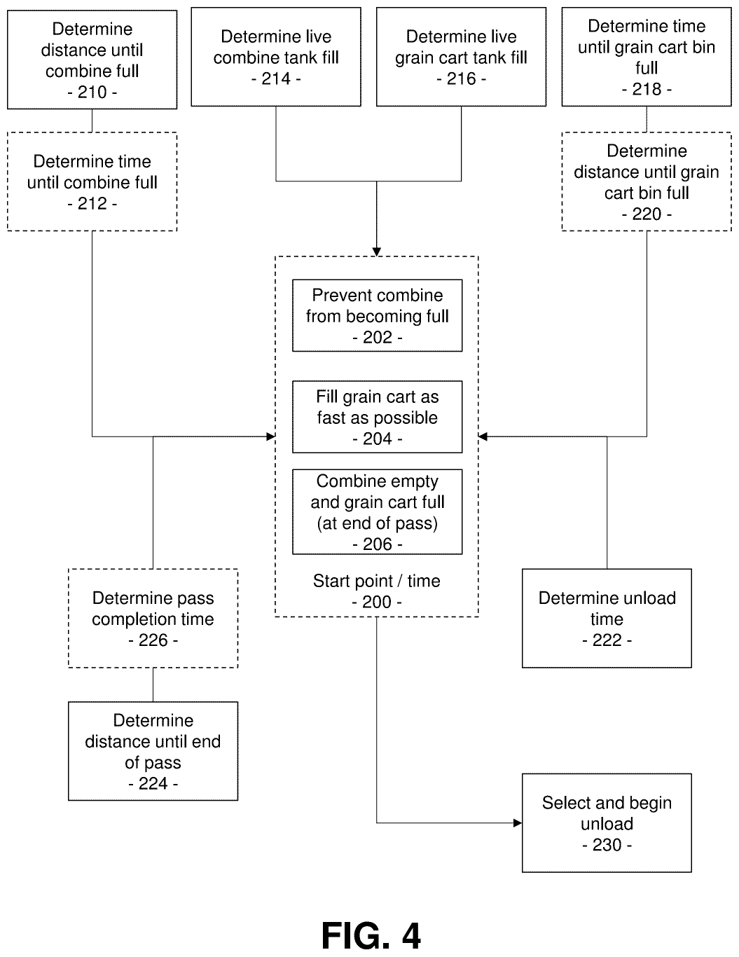

The system 50 may be configured to execute a series of one or more steps, each of which is optional, and may be performed in any order or not at all. In certain implementations, the steps are executed sequentially, continuously, periodically, and/or iteratively. The system 50, in various implementations, is configured to execute these steps to determine when and/or where to begin unloading of a harvester into a cart (box 200). An exemplary series of steps is shown in FIG. 4.

### Preventing Combine from Becoming Full

### 1. Where to Unload

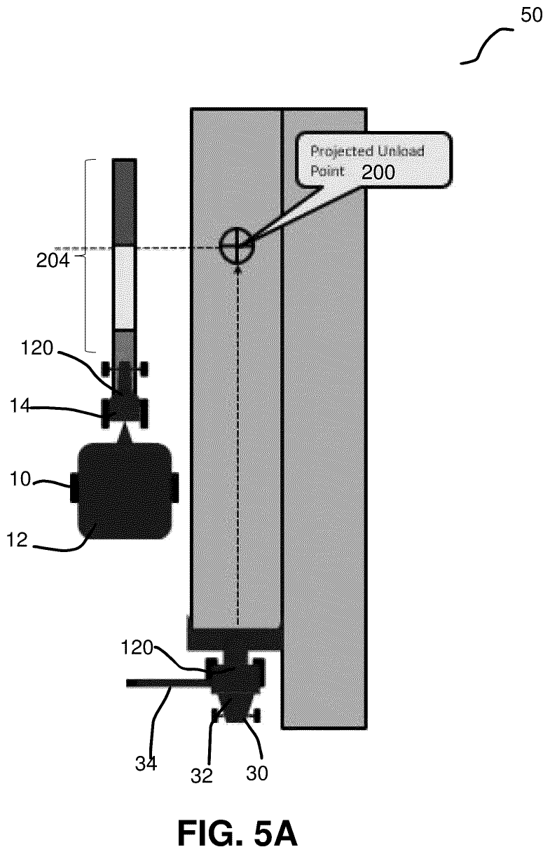

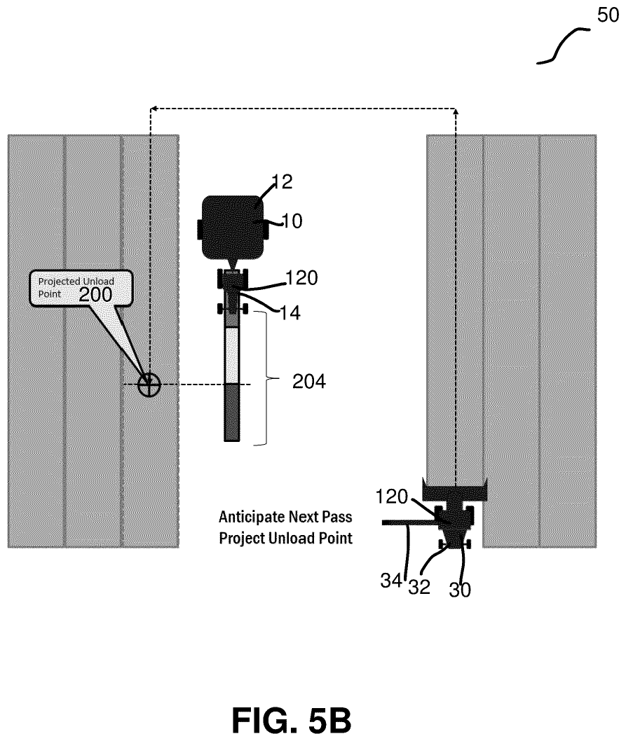

In various implementations, the system 50 is configured to prevent a combine bin 32 from becoming full (box 202) and therefore needing to stop for unloading before continuing harvesting. In one optional step, the system 50 determines a location for where to start unloading on-the-go (box 200). In various implementations, the system 50 estimates the distance/time the harvester can travel while harvesting until it reaches its bin capacity—bin full (boxes 210 and 212). Using this value, time until full or distance until full (boxes 210 and 212), the system 50 projects a location in the field where the grain cart 10 can begin unloading on-the-go to prevent the harvester bin 32 from becoming full, as shown for example in FIGS. 5A and 5B where the unload point is indicated at 200. That is, the start unload location 200 is before the location where the harvester 30 is predicted to be full.

In one optional step, the system 50 determines a Distance Until Combine Bin Full value (box 210). The Distance Until Combine Bin Full value may be based on one or more if combine tank capacity (CTC), combine tank level (CTL), and average grain flow rate (AGFR). The Distance Until Combine Full value (box 210) is the estimated harvest distance the combine can go until it reaches its bin capacity. As shown in FIG. 4, this value is used to project a spot ahead of the combine 30 where the grain cart 10 can wait to start unloading on-the-go. As would be understood, when the combine 30 harvests up to this spot 200, the combine bin 32 will be or almost will be full, but if the combine 30 begins unloading at the point it can continue to harvest because it will be unloading on-the-go.

Optionally, the grain cart 10 could start unloading the combine 30 sooner than the start point 200, but this could cause more grain cart 10 drive distance, which exposes more field area to soil compaction. By predicting the distance until full (box 210), and thereby location where the combine bin 32 will be full, grain cart 10 operators and autonomous grain carts 10 know where to wait or meet the combine to begin unloading on-the-go.

In certain implementations, the Distance Until Combine Bin Full value (box 210) is calculated as:

$$Distance until combine full = \frac{C T C - C T L}{A G F R}$$

In a further optional step, the start location 200 is communicated to a combine 30 operator and a grain cart 10 operator, such as by displaying the start location (and optionally time) on the display (shown at 120 in FIGS. 2 and 3). In certain implementations, such as when the combine 30 and/or grain cart 10 are being driven automatically or semi-automatically, the start location 200 may be communicated to the automatic steering system to drive the vehicles 10, 30 to the start location and automatically or semi-automatically begin the unloading process.

As would be understood, the combine tank capacity (CTC) can optionally be inputted by a user, retrieved from a memory/storage, and may be displayed on a user interface, such as that shown in FIG. 3. The CTC may optionally be displayed as a weight, such as pounds (lbs.). The Combine Tank Level (CTL) may optionally be determined from a bin level sensor and/or scale system as would be understood. The CTL may optionally be displayed as a weight, such as pounds (lbs.).

In various implementations, the Average Grain Flow Rate (AGFR) is optionally calculated as a rolling average using cumulative harvest distance and grain flow values from the last empty tank signal. In these and other implementations, the system 50 determines a distance traveled, such as from a navigation system 122 (e.g., GPS) and/or a distance sensor. The grain flow values can be obtained from a flow sensor and/or yield monitor (shown for example at 108 in FIG. 2). The system 50 may optionally be configured to begin a new AGFR rolling average with each new empty bin signal (optionally obtained from a tank empty sensor, shown at 114 in FIG. 2).

In alternative implementations the AGFR can be estimated from a stored AGFR from a prior/nearby harvested pass.

AGFR can be expressed in a myriad of ways including yield per acre, yield per time, or yield per distance. Various adjustments to the algorithm and calculation can be made to accommodate the measured/calculated AGFR.

### 2. When to Unload

Continuing with FIG. 4, in further optional step, the system 50 determines when to start unloading on-the-go (box 200). Using the Time Until Combine Full (box 212), discussed above, the system 50 can estimate the time it will take for the combine bin 32 to fill. This time can be displayed to a combine 30 operator, such as via a display 120. The time can also be displayed to a grain cart 10 operator, such as via a display 120. The time to start unloading (box 200) can be displayed instead of or in addition to the location to start unloading (box 200), discussed above.

In a further optional step, the system 50 determines a Time Until Combine Full (box 212) based on combine tank capacity (CTC), combine tank level (CTL), average grain flow rate (AGFR), and average combine speed (SPD). In certain implementations, the Time Until Combine Full value (box 212) is calculated as:

$$Time until combine full = \frac{C T C - C T L}{A G F R \times S P D}$$

### 3. Combine Grain Tank Fill

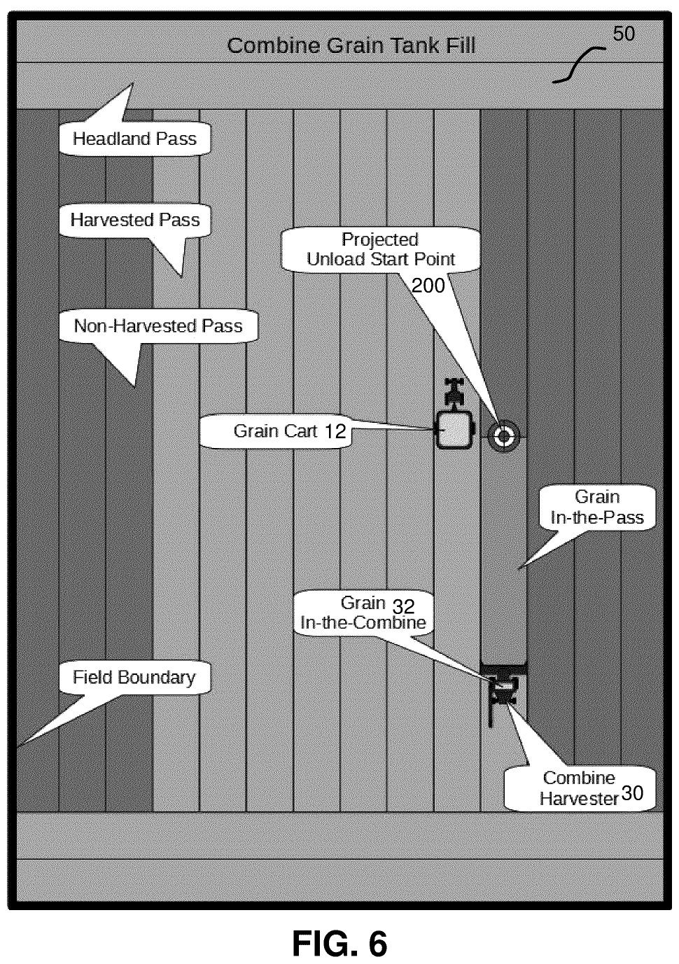

In various implementations, the system 50 is configured to determine the live fill level of the combine grain tank (CTL) (box 214). As shown in FIG. 6, the combine 30 during harvest is filling its grain tank 32. The system 50, in various implementations is configured to project an anticipated start unload point 200. The system 50 may use the live fill level of the combine grain tank 32 to determine when/where in the field the next unload would need to begin to prevent the bin 32 from becoming full and requiring the combine 30 to stop, this calculation must take into account the crop that will be harvested between the current location of the combine 30 and the unload point 200. The live CTL can be determined using Combine grain tank capacity [kg] (CTC), Combine speed [m/s] (SPD), Combine grain tank level (weight) [kg] (CTL), Combine grain mass flow [kg/s] (CFR), Combine average grain mass flow rate (AGFR). Further, a speed-adjusted flow rate may be calculated where the rate is determined as:

$$\frac{CTL}{Distance \times SPD}$$

Each second, the amount of grain measured by the yield monitor (kg/s) is added to the combine grain tank weight (kg) (CTL). The combine grain mass flow (CFR) may be calculated based on the speed-adjusted flow as described above.

The amount of time until the combine grain tank is full (box 212) or the time left to unload (TLU) is:

$$T L U = \frac{C T C - C T L}{C F R}$$

The distance until the combine grain tank is full (box 210) or the distance left of unload (DLU) is:

DLU=TLU*SPD

### 4. Starting Point for Unloading On-the-Go

In various implementations, the system 50 is configured to determine a start unload time/location in order to completely fill the grain cart bin 12 as the combine bin 32 becomes empty (box 206). That is, when the system 50 is configured to determine when to begin unloading (box 200) the combine bin 32 into the grain cart bin 12 such that the grain cart bin 12 is full when the combine bin 32 is empty to maximize utility of both.

In these and other implementations, the system 50 in one optional step determines the Time Until the Grain Cart is Full (box 218) using the Grain Cart Capacity (GCC), Grain Cart Level (GCL), Combine Tank Level (CTL), Average Grain Glow Rate (AGFR), Combine Unload Auger Rate (UAR), and Combine Speed (SPD). In various implementations, the GCC is user entered into a user interface, or optionally is retrieved from a system 50 memory (such as a memory 154 shown in FIG. 2). The GCL can be determined from the grain cart scale system (such as the bin based system 152 or serial based system 154 shown in FIG. 2). The UAR can be a known or user entered value. Alternatively, the UAR can be calculated from grain cart scale system data, as would be appreciated.

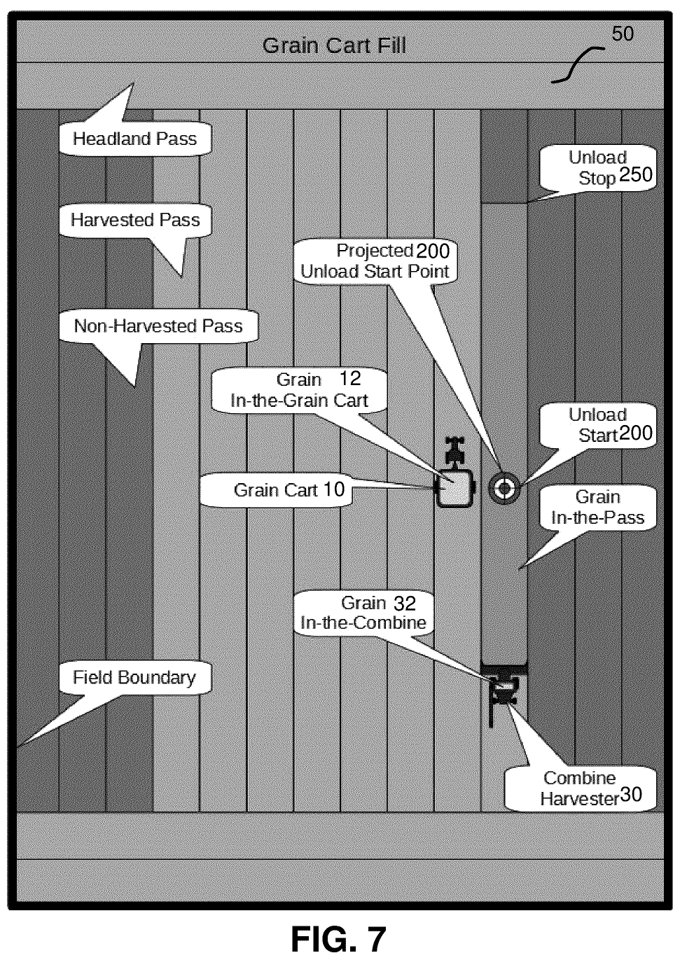

The Time Until Grain Cart Full (box 218) is the amount of time it will take the combine 30 to harvest enough crop to completely fill the grain cart bin 12—from the start of unload 200 to the end of unload 250. As can be seen in FIG. 7, when unloading on-the-go the combine 30 will continue to harvest while the crop is being unloaded into the grain cart 30. During this time the grain cart 30 will drive alongside the combine 30 until the grain cart 10 is full or the combine bin 32 is empty, in which case the grain cart 10 will wait until the next unload to unload more grain before delivering the drop to a transport vehicle, as would be appreciated. The Time Until Grain Cart Full (box 218) is calculated as:

$$Time until grain cart full ( secs ) = \frac{G C C - G C L - C T L}{A G F R \times S P D} - \frac{G C C - G C L}{U A R}$$

The Distance Until Grain Cart Full (box 220) is the distance the combine 30 needs to harvest to have enough grain to completely fill the grain cart bin 12. The Distance Until Grain Cart Full (box 220) is also the distance ahead of the combine 30 where the grain cart 10 should wait for/meet the combine 30 to begin unloading. The Distance Until Grain Cart Full (box 220) is calculated as:

Distance until grain cart full (feet)=Time until grain cart full×SPD

### Fill Grain Cart as Quickly as Possible

In certain implementations, the system 50 is configured to fill the grain cart 10 as quickly as possible (box 204). As would be appreciated, the sooner the grain cart 10 can head to the hauling vehicle and unload, the sooner it can get back and unload the combine 30 before the combine 30 gets stopped by a full tank 32. Filling the grain cart 10 as soon as possible decreases the chance the combine 30 will have to stop before the next unload can begin.

Using the formulas above for Time Until Grain Cart Full (box 218) and Distance Until Grain Cart Full (box 220) the grain harvested during the unload event (start location 200 to stop location 250) is accounted for, as shown in FIG. 7. The grain cart 10 can optionally start unloading the combine 30 sooner than the determined starting point 200, but this causes more grain cart 10 drive distance, increasing undesirable compaction. Starting the unload later than the system 50 estimation can waste time because it delays unloading the grain cart 10 into the hauling vehicle.

Because the grain flow rate (GFR/AGFR) is an estimate, the system 50 may calculate and present a buffer 204 distance ahead of and behind the calculated unload point 200 due to the uncertainty in location because of variances in yield and other factors (as shown in FIGS. 5A and 5B). Calculating and presenting an optional buffer 204 allows for the actual unload point to end up ahead of or behind the calculated unload point 200 due to a higher or lower than estimated actual grain flow.

When the grain cart 10 is near full and the next unload will be to fill the grain cart 10 to capacity, the combine 30 operator may optionally want the combine grain tank 32 to be emptied as the grain cart grain tank 12 is filled to capacity. This is the most efficient way to complete the filling of the grain cart tank 12 and allow maximum time for the grain cart 10 to move the crop to a transport vehicle before the combine 30 fills. Therefore, when the system 50 determines how much grain there is to be unloaded to the grain cart 10, the system 50 includes the estimated amount of grain that will be harvested during unload to the cart 10.

The unload time (box 222) (time to unload from start point 200 to stop point 250) is equal to the combine grain tank weight (CTL) divided by the result of unload rate minus calibrated crop flow. This way, the system 50 accounts for grain leaving the combine grain tank 32 and grain coming into the combine grain tank 32 during the unloading on-the-go process. The time to fill the grain cart bin 12 is then the remaining cart capacity (kg) divided by the calibrated unload auger flow, this total minus the unload time (box 222). If the system 50 did not account for the grain harvested during the unload period, then the grain cart 10 would have to wait longer than needed before starting the unload and the combine grain tank 32 will not be at or near empty when the grain cart 10 is completely filled.

In implementations where the goal is to fill a grain cart 10 to capacity, a similar approach may be used for calculating the time for unloading (box 222). In these implementations, the system 50 accounts for the grain harvested during unload (and added to the grain cart tank 12). But in these implementations, the grain cart 10 may not be filled to capacity. Accounting for the grain to be harvested during unload allows the unload to start at the earliest possible time.

The Time-Left-To-Unload (TLU) for grain cart (or grain truck) full is calculated according to the following equation:

$$T L U = \frac{G C C - G C L - C T L}{C F R} - \frac{G T W}{U L R - C F R}$$

The Distance-Left-to-Unload (DLU in m) is calculated as:

DLU=TLU*SPD

To calculate the grain tank (or grain truck) fill point the system 50 determines or acquires the Grain cart capacity (GCC) or Grain Truck Capacity; Grain cart level (GCL) or Truck Weight; Combine speed [m/s] (SPD); Combine grain tank level (weight) [kg] (CTL); Combine grain mass flow [kg/s] (CFR) (optionally the combine average grain mass flow rate or a speed-adjusted flow rate, as discussed above; and the combine unload auger mass flow rate [kg/s] (ULR).

To determine the amount of grain to be harvested in a pass the system 50 can execute a series of optional steps. In certain implementations, the amount of grain to be harvested in a pass is calculated using the average of mass per unit distance for the current grain tank load. If the yield is consistent (low variability) across the field, this may be able to provide a reasonably accurate estimate. In cases where the yield is highly variable, this approach may cause an over- or under-estimation of grain remaining in the pass which then causes the time and distance to unload point to be inaccurate.

Highly variable yields may require alternative approaches to estimating grain remaining in the pass. For example, one alternative approach includes use of mass flow data from a previous adjacent pass information to estimate the grain remaining in the current pass. Further additional approaches include the use of previous harvest information for the field to build an estimate for mass flow; use previous collected imagery (aerial/satellite) to build an estimate for mass flow; and/or use a collection of previous operational information for the field (including tillage operations, previous crops, nutrients applied, etc.), weather information (as collected by in-field sensors or other sources of weather information), imagery (aerial, satellite, or other), crop scouting information (human observation and sampling), soil sampling information, and other information that may be useful in evaluating the health of a crop and its potential yield.

### Empty Combine Bin at the End of Pass

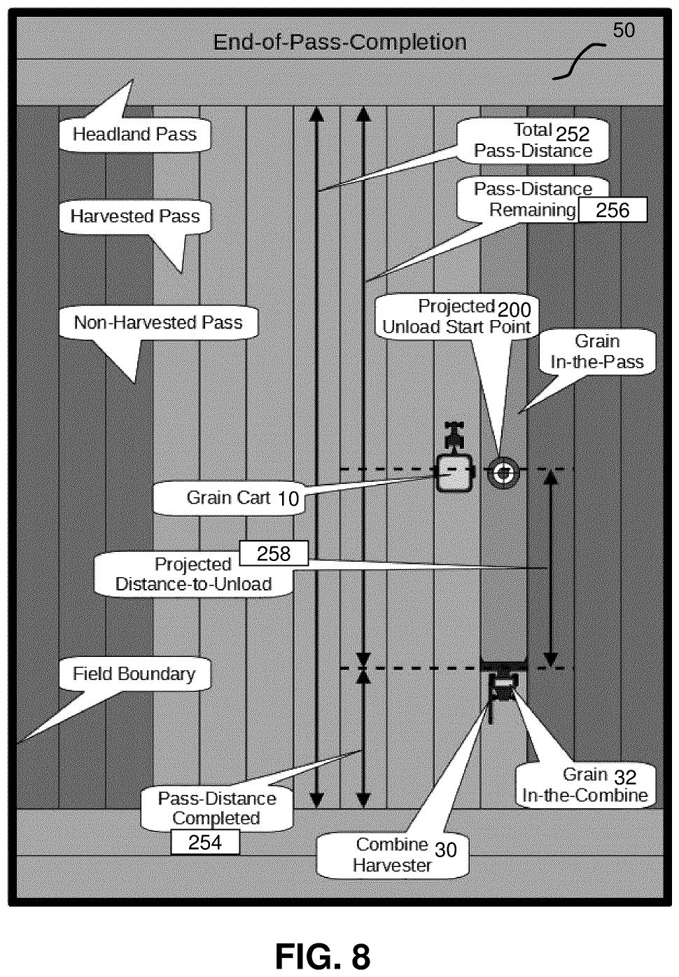

In various implementations, the system 50 is configured to determine an unloading starting point such that the combine bin is empty at the end of a pass (box 206). Empty-on-Pass-Completion is an unload strategy where the combine 30 operator wants the unload to the grain cart 12 to start at a position that results in the combine grain tank 32 being emptied as the field pass is completed, as shown in FIG. 8. As would be understood, a field pass 252 is a continuous stretch of unharvested crop, the operating width of the harvester 30, following some path through the field, often running parallel to one of the field boundaries. Typical grain harvest in a field starts with harvesting the ends of the field first, so the combine 30 and grain transport equipment (grain cart 10) have room to operate and turn around at the ends of the field. Then, the field is harvested as a series of passes back and forth between the harvested ends. For some, it may be advantageous to have the combine 30 be empty at the completion of the pass, so it is desirable for a system 50 to be capable of finding the optimal unload start point 200 to achieve empty-on-pass-completion (box 206).

In one optional step, the distance to the end of pass (EOP) (box 224) is the distance back from the end of the pass that will be needed to unload combine bin 32 so that it is empty at the end of the pass. The distance to the end of the pass (EOP) is calculated as:

$$EOP ( ft ) = \frac{- C T L * S P D - R D * A G F R * S P D}{A G F R + B L U R}$$

In this equation CTL is the combine tank level, AGFR is the average grain flow rate, the LPD is the last pass distance 252 or harvested distance since the last pass, CPD is the current pass distance 254; the RD is the remaining distance 256 in the pass (LPD—CPD), UAR is the combine unload auger rate; BLUR is the combine tank level unload rate (UAR— AGFR).

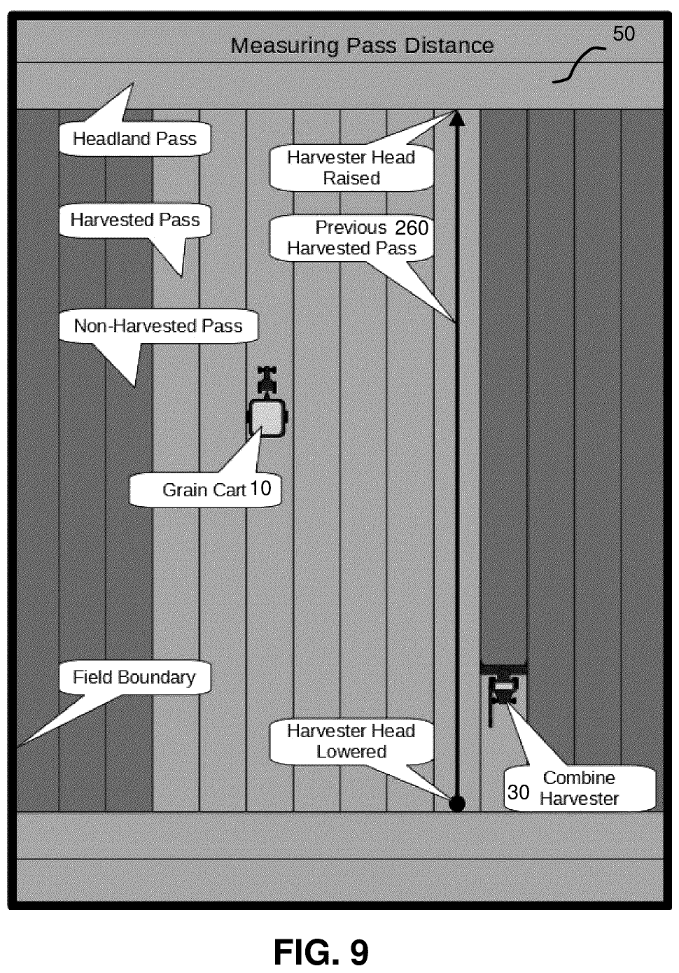

In a further optional step, the system 50 determines a projected unload distance 258 based on the remaining pass distance 256. The remaining pass distance 256 can be determined by a myriad of ways including measuring the previous pass distance 260 by using combine speed to accumulate distance from when the combine header is lowered to start harvesting to the point the header is raised at the end of the pass to stop harvesting, as shown for example in FIG. 9. The system 50 determines the total pass distance 252, and optionally assumes the total pass distance 252 is approximately equal to the distance of the last pass 260, and subtracts the current position of the combine 30. In various implementations, the pass distance 252 is a stored value, such as from a planter (as-planted information). In certain implementations, the system 50 may retrieve the total pass distance 252 from planting data by spatially matching the combine GPS location to the planter pass spatial data. The EOP distance can then be subtracted from the remaining pass distance 256, that is the distance ahead of the combine to the location where unloading should start unload 200 to empty the combine bin 32 by the end of the pass (box 206). The projected unload distance 258 can be determined based on EOP and RD and is calculated with the following formula:

Projected Unload Distance=RD−EOP

In various implementations, to determine the unload time (box 222) the system 50 determines the pass completion time (box 226). The pass completion time (box 226) can be calculated as the remaining pass distance divided by the combine speed. The time until unload can then be based on the Projected Unload Distance and SPD:

$$Time Before Unload = \frac{Projected Unload Distance}{SPD}$$

In various implementations, the system 50 determines a wait time before starting to unload on-the-go based on the speed of the combine 30 and the projected unload distance.

The Time-Left-to-Unload (TLU) for end-of-pass-completion is calculated according to the following equation:

$$T L U = \frac{( P C T * U L R ) - G T W - ( P C T * C F R )}{U L R}$$

The Distance-Left-to-Unload (DLU in m) is calculated as:

DLU=TLU*SPD

Various methods and devices are possible for determining pass distance 252. One approach includes measuring the distance accumulated from when the header is lowered to start harvesting for the pass to when the header is raised to stop harvesting at the end of the pass, as shown in FIG. 9. Alternative methods and devices are possible including use of a wheel rotation sensor to count pulses as a vehicle wheel rotates, where pulses equate to distance traveled across the ground. A further alternative includes wheel speed sensor where the wheel speed sensor returns a speed (m/s) and speed is sampled each second and converted to a distance, which is accumulated. A still further alternative includes the use of a GPS (GNSS) speed, in this implementation a GPS receiver uses satellite-based radio signals to determine position and speed and like wheel speed, GPS speed is sampled each second, converted to a distance, and accumulated to measure a total distance. In a still further alternative implementation distance between GPS positions at start and stop harvesting (lowering and raising header) is used.

In various implementations, a field computer (with display 120) in the combine 30 is used for collecting mass flow data from the yield monitoring system 108 and geo-positioning that data to a point in the field. The field computer receives position information from a connected GPS 122 (or GNSS) receiver. The field computer can keep track (geo-spatially) where the harvester 20 has already completed harvesting the crop, including the field passes where the header was lowered and raised. The field computer may also have a representation of the field boundary (in geo-spatial coordinates). An advanced algorithm in the field computer may examine the current location of the harvester 30 compared to previous pass information and/or the field boundary. This algorithm will then determine the appropriate pass distance and the pass-distance remaining. A field computer may also use previous operational information for the field (e.g. the planting operation) to determine the pass length. In the case of planting, the previous data collected during planting would include where the planter started the planting pass and where it ended the planting pass. If the combine 30 follows the planting passes, as in row crops like corn, the harvesting pass distance is simply the planting pass distance for the pass that the combine is following.

### Determining Unload Time and Location

Continuing with FIG. 4, in various implementations, the system 50 selects from the three projected start points (box 200) (combine full (box 202), grain cart full (box 204), combine empty by end of pass (box 206)) by choosing the start point with the shortest distance from the current location of the combine 30 or the shortest time. In these and other implementations, the shortest distance ahead of the combine represents the unload scenario that is highest priority.

In certain implementations, the projected unload distance (box 200) is longer than the unharvested distance in the current pass. In these cases, the system 50 may show the projected unload point (box 200) on an anticipated next pass, as shown in FIG. 5B. The system 50 may use previous history, nearest unharvested crop, or some other means to estimate where the combine will continue harvesting after the current pass is completed.

### Unload Auger Rate

The system 50 may automatically calculate the combine unload auger rate (UAR) using the grain cart scale system (such as that at 152 and 154 of FIG. 2), discussed briefly above. Via wireless data transfer, the grain cart 10/150 and combine 30/100 systems can determine the unloading time and the amount unloaded. The system 50 can divide total amount unloaded by total unloading time to determine UAR. For example:
Grain Cart scale weight at start of unload: 10,000 lbs
Grain Cart scale weight at end of unload: 25,000 lbs
Total unload time: 83 seconds

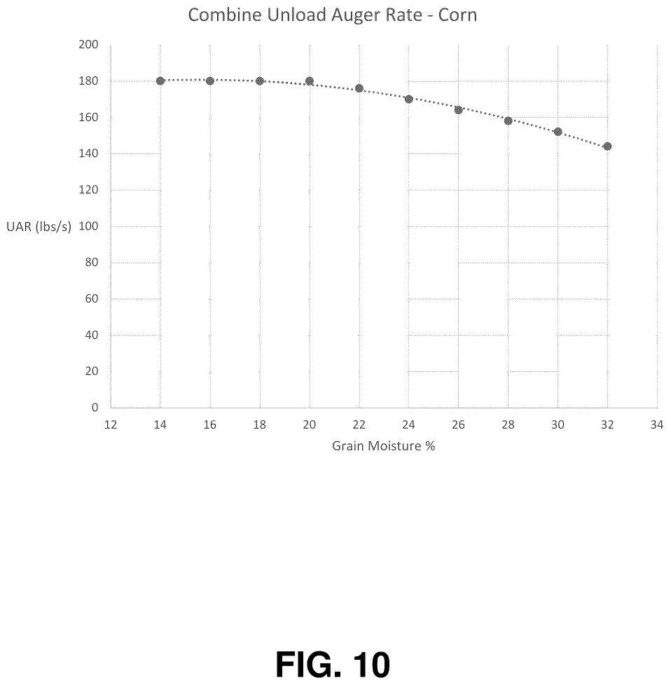

UAR is known to decline when harvesting corn as grain moisture rises above 20-22%. UAR variation in other crops like soybeans and wheat that are harvested below 20% moisture is often minimal. The system 50 may optionally perform a new UAR calculation with each unload to account for UAR variation due to grain moisture. The system 50 may also store multiple UAR numbers by grain moisture and/or grain type. The system 50 may utilize a UAR grain moisture calibration curve established from prior unload data. Shown for example in FIG. 10.

### Grain Cart on/Off Indicator

Grain carts are usually very tall and wide with respect to the pulling tractor, as shown in FIG. 1. At the onset of unloading on-the-go, the grain cart 10 operator often tries to determine on/off status of the auger 34 by looking above the grain cart 10 for grain flowing out of the combine unloading auger 34 spout. The trouble is the front wall of the grain cart 10 often obstructs the unloading auger 34 view. In various implementations the system 50 includes an audible and/or visible indicator to the grain cart 10 tractor operator of when the combine unload auger 34 turns on and off.

As soon as the combine 30 operator turns on the unloading auger 34, the system 50 may send a wireless message to the grain cart 10/150 system to trigger an audible and/or visible signal in the grain cart 10 tractor, such as on the display 120. Likewise, the system 50 sends another message as soon as the combine 10 operator turns off the unloading auger 34. A distinct on and off audible signal may be the most useful indicator as the grain cart 10 operator may be executing multiple operations and unable to look at the visible indicator. For example, the grain cart 10 operator may be in charge of steering, speed control, and avoiding/navigating upcoming field obstacles (e.g., washouts, gullies, poles, etc.).

A distinct on and off audible signal is preferred over indistinct because grain cart 10 operators may otherwise lose track of on/off status. This is especially true when the unload auger 34 is cycled on/off more than once during an unload event. An example of distinct sounds is a double beep for “on” and a triple beep for “off.” Other patterns or sounds are possible and contemplated herein. Distinct audible signals work well because they are a hands free and eyes free indicator of the auger 34 status.

It may be helpful for the grain cart 10 operator to know when the combine 30 unloading auger 34 turns on and off while unloading on-the-go because the “on” indicator tells the grain cart 10 operator that the combine 30 operator thinks the grain cart 10 is in an acceptable position to start unloading. It also means thereafter grain will spill on the ground if the grain cart 10 gets too far ahead or behind the unloading auger 34. Thus, the “on” signal brings a heightened sense of awareness to pay special attention during this unload process to avoid spillage.

A delayed “on” indicator after the grain cart 10 pulls under the unloading auger 34 infers the combine 30 operator thinks conditions are unsuitable to start unloading on-the-go. In these situations the grain cart 10 operator may need to position the grain cart 10 in a better spot under the unloading auger 34. Alternatively, it is possible a field obstacle is approaching which may cause separation between the grain cart 10 and combine 30/auger 34. There are numerous unsuitable conditions that may occur and would be appreciated by those of skill in the art. Without this indicator, the grain cart 10 operator may errantly assume the unloading auger 34 is on and not react to the unsuitable condition.

The “off” indicator lets the grain cart 10 operator know the combine 30 operator has shutoff the auger 34 for one of the following reasons: the combine tank 32 is empty; the grain cart bin 12 is full; the grain cart bin 12 area under the auger 34 is full; and/or the grain cart 10 needs to reposition to an area under the unloading auger 34 that is not full.

In certain situations the “off” indicator is triggered when the unloading event is over and as such the grain cart 10 can pull away from the combine 30. After the “off” signal appears, the grain cart 10 operator may look at the combine bin 32 level and/or grain cart bin 12 level displayed on the grain system 50/150 to understand why the combine 32 operator turned the auger off.

The system 50 can optionally determine the combine unloading auger 34 on/off status via a message(s) from the combine 32 electronic system or a motion sensor (e.g., rotation) on a mechanical unload auger driveline component. If combine unload auger 34 status is unavailable to the combine system 100, the grain cart system 150 may employ an algorithm that uses change in grain cart 12 weight for the on/off trigger. For example, the algorithm may set the unload auger 34 status to “on” when the grain cart bin 12 weight maintains a continuous weight increase as defined by certain thresholds. It may set the unload auger 34 status to off when the criteria are not met.

Although the disclosure has been described with reference to certain implementations and embodiments, persons skilled in the art will recognize that changes may be made in form and detail without departing from the spirit and scope of the disclosed apparatus, systems and methods.

What is claimed is:

1. A combine unloading management system comprising one or more processors and one or more computer-readable storage media comprising instructions that configure the one or more processors to:
determine a grain flow rate of grain flowing into a combine tank of a combine harvesting along a current pass of a grain field;
determine a combine tank level corresponding to a current amount of grain in the combine tank; and
determine a starting point for unloading the combine tank on-the-go into a grain cart, the starting point based on the grain flow rate and the combine tank level.

2. The combine unloading management system of claim 1, wherein the one or more processors are configured to wirelessly transmit the starting point to a display for viewing by an operator of the grain cart.

3. The combine unloading management system of claim 1, wherein the starting point comprises a position in the current pass or a subsequent pass at which the combine will start unloading on-the-go into the grain cart.

4. The combine unloading management system of claim 1, wherein the starting point comprises a time at which the combine will start unloading on-the-go into the grain cart.

5. The combine unloading management system of claim 1, wherein the one or more processors are configured to determine a plurality of starting points for unloading the combine tank on-the-go into the grain cart and select one of the plurality of starting points that is closest to a current position of the combine.

6. The combine unloading management system of claim 5, wherein the plurality of starting points comprises at least two of:
a first starting point so that the combine tank is about full at the first starting point before unloading;
a second starting point so that the grain cart is about full and the combine tank is about empty after unloading the go into the grain cart; and
a third starting point so that the combine tank is about empty at an end of the current pass after unloading on-the-go into the grain cart.

7. The combine unloading management system of claim 1, further comprising a grain mass flow sensor and an empty tank level sensor, and wherein the one or more processors are configured to determine the grain flow rate based on an average of a grain mass value received from the grain mass flow sensor since last receiving an empty tank signal from the empty tank level sensor.

8. The combine unloading management system of claim 1, wherein the one or more processors are configured to determine the grain flow rate of the current pass based on a grain flow rate of a previously harvested pass.

9. A combine unloading management system comprising:
a first controller disposed on a combine, the first controller comprising a housing, a first radio, and a first processor mounted within the housing in operative communication with the first radio and configured to:
determine a grain flow rate of grain flowing into a combine tank of the combine as the combine harvests along a current pass of a grain field;
determine a combine tank level corresponding to a current amount of grain in the combine tank;
determine a starting point for unloading the combine tank on-the-go into a grain cart, the starting point based on the grain flow rate and the combine tank level; and
transmit the starting point to the grain cart with the first radio.

10. The combine unloading management system of claim 9, further comprising a grain mass flow sensor and an empty tank level sensor, wherein the first processor is further configured to:
receive a grain mass value from the grain mass flow sensor;
receive an empty tank signal from the empty tank level sensor; and
determine the grain flow rate based on an average of the grain mass value since last receiving the empty tank signal.

11. The combine unloading management system of claim 9, wherein the first processor is further configured to determine the grain flow rate of the current pass based on a grain flow rate of a previously harvested pass.

12. The combine unloading management system of claim 9, wherein the first processor is further configured to determine the starting point additionally based on a combine tank capacity of the combine tank so that the combine tank is about full at the starting point before unloading on-the-go into the grain cart.

13. The combine unloading management system of claim 9, further comprising a second controller disposed on the grain cart, the second controller comprising a housing, a second radio, and a second processor mounted in operative communication with the second radio and configured to receive the starting point with the second radio and display the starting point for viewing by an operator of the grain cart.

14. The combine unloading management system of claim 13, wherein the second processor is further configured to transmit a grain cart level and a grain cart capacity of the grain cart to the first controller with the second radio, and wherein the first processor is further configured to:
determine the starting point additionally based on the grain cart level, the grain cart capacity, and an unload auger rate of the combine; and
determine the starting point so that the grain cart is about full and the combine tank is about empty after unloading the combine tank on-the-go into the grain cart.

15. The combine unloading management system of claim 9, wherein the first processor is further configured to:
determine the starting point additionally based on an unload auger rate of the combine, a speed of the combine, and a remaining distance of the current pass to be harvested; and
determine the starting point so that the combine tank is about empty at an end of the current pass after unloading the combine tank on-the-go into the grain cart.

16. The combine unloading management system of claim 9, wherein the first processor is further configured to determine a plurality of starting points and select one of the plurality of starting points corresponding to a shortest distance from a current position of the combine and/or corresponding to a shortest time period before unloading the combine tank on-the-go into the grain cart.

17. A method for alerting a grain cart operator when a combine auger is on and off, comprising:
detecting the on/off status of the combine auger;
transmitting the on/off status of the combine auger to a grain cart;
issuing an audible and/or visual alarm to alert a grain cart operator of the on/off status of the combine auger.

18. The system of claim 17, wherein the alarm is an audible alarm with a first distinct sound to indicate auger on and a second distinct sound to indicate auger off.

19. The system of claim 17, wherein the on/off status of the combine auger is detected via electronic messages from a combine electronic system or motion sensor on the combine auger.

20. The system of claim 17, wherein the on/off status of the combine auger is detected via a grain cart scale system, wherein when the grain cart scale system detects the combine auger is on when the grain cart scale system detects a continuous weight increase for a threshold period of time.
